(19) United States
(12) Patent Application Publication
(10) Pub. No.: US 2026/0155892 A1
(43) Pub. Date: Jun. 4, 2026

(54) SYSTEM AND METHOD FOR SATELLITE COMMUNICATION USING HYBRID OPTICAL AND MMWAVE TRANSCEIVER

(71) Applicant: The Hong Kong University of Science and Technology, Hong Kong (CN)

(72) Inventors: Chik Patrick YUE, Hong Kong (CN); Li WANG, Shaanxi (CN)

(21) Appl. No.: 19/352,499

(22) Filed: Oct. 8, 2025

Related U.S. Application Data
(60) Provisional application No. 63/727,207, filed on Dec. 3, 2024.

(51) Int. Cl. H04B 10/40; H04B 10/07; H04B 10/516

(52) U.S. Cl. CPC H04B 10/40; H04B 10/07; H04B 10/516

(57) ABSTRACT

A system comprises a decision logic module, a payload IC, an optical transceiver, a mmWave transceiver, and an antenna array. The decision logic module evaluates channel conditions and selects one of four transmission modes based on a signal quality indicator. The payload IC generates baseband data and receives demodulated data. The optical transceiver, coupled to the decision logic and payload IC, transmits and receives optical signals via a free-space link using either a first or second modulation format. The optical array handles optical signal emission and reception. The mmWave transceiver, coupled to the decision logic and payload IC, transmits and receives mmWave signals via a free-space mmWave link using a third or fourth modulation format. The antenna array supports mmWave emission and reception. The first modulation format offers higher spectral efficiency than the second. The third provides a higher data rate than the fourth under favorable signal-to-noise conditions.

Cross-Reference to Relevant Applications :

The present application claims priority from a U.S. provisional patent application serial number 63/727,207 filed December 3^{rd}, 2024, and the disclosure of which are incorporated by reference in their entirety.

### Technical Field

The present invention relates to satellite communication; in particular, to a system and method for satellite communication using hybrid optical and millimeter-wave (mmWave) transceivers.

### Background

Satellite communication is essential in today’s world, enabling high-speed and low-latency global connectivity and data exchange without physical optical fiber or cable link. It’s crucial for telecommunications, broadcasting, military operations, weather forecasting, and GPS. Satellites provide real-time communication in remote areas, bridging the digital divide and offering services like emergency communications and internet access.

FIG. 1 illustrates an exemplary scenario of a hybrid optical and millimeter-wave (mmWave) network architecture for data transmission in satellite communication. Satellite communication encompasses the transmission between satellites and the communication between satellites and ground stations. Traditional satellite communication relies on radio frequency wireless communication methods, including mmWave links. However, such techniques encounter various challenges. Firstly, mmWave communication transmits in an omnidirectional manner, leading to lower overall power efficiency in the communication system. Secondly, due to narrowband operations and limited signal-to-noise ratios, the data rates of mmWave links typically remain below 10 Gbps per user, even with advanced modulations like 16-QAM or 64-QAM. To enable communication for multiple users simultaneously, a phased array architecture is necessary to offer space-division multiplexing functionality. However, the non-trivial sidelobe effects severely restrict the total number of concurrent beams, placing constraints on communication capacity. Nevertheless, mmWave technology does present certain advantages. It offers relatively higher data rates compared to conventional low-frequency sub-6GHz RF links. Additionally, it ensures robust data transmission quality in space atmospheric environments for intersatellite communication and withstands adverse weather conditions for communication between satellites and ground stations.

In contrast to the mmWave link, the optical wireless link transmits signals in free space via a highly collimated laser. The optical wireless link offers two significant advantages over the mmWave link. Firstly, operating in the wideband mode allows for bandwidths as high as 20 GHz or more. Coupled with a coherent modulation scheme, this enables the optical wireless link to potentially support data rates of up to tens of Gbps, such as achieving 80 Gbps using 16-QAM coherent modulation with a 10 GHz bandwidth. Secondly, due to the high directivity of the laser with collimator, the optical signal can traverse long distances with significantly lower loss compared to omnidirectional transmission with mmWave signals. However, the optical wireless link is susceptible to issues such as scattering in the atmosphere and adverse weather conditions, which can greatly impact the strength of the optical signal or even obstruct the link entirely.

Accordingly, there is a need for a hybrid optical and millimeter-wave transceiver system capable of dynamically adapting to varying atmospheric conditions to maintain high-speed and reliable satellite communication.

### Summary of Invention

It is an objective of the present invention to provide a system and a method to address the aforementioned shortcomings and unmet needs in the state of the art.

In the present invention, a novel physical layer transceiver implementation designed to achieve high-speed and robust satellite communication is introduced. The configuration focuses on the architecture, operational principles, and implementation details of a hybrid mmWave/optical wireless communication transceiver for communication between satellites and between satellites and ground stations. The hybrid transceiver employs decision logic to adaptively activate either the optical wireless or mmWave link by assessing the communication channel conditions. Additionally, the modulation format can be dynamically optimized to ensure a sufficient signal-to-noise ratio and robust communication quality. The solution provided in the present invention includes a power-efficient mmWave phased-array transceiver that supports simultaneous multi-beam functionality, as well as an optical wireless transceiver with an adaptive modulation scheme. Compared to conventional approaches, the solution provided in the present invention has the potential to deliver higher data rates, enhanced robustness, and improved power and area efficiency.

In accordance with a first aspect of the present invention, a system for satellite communication using hybrid optical and mmWave transceivers. The system includes a decision logic module, a payload integrated circuit, an optical transceiver, an optical array, a mmWave transceiver, and an antenna array. The decision logic module is configured to evaluate a channel condition and select a transmission mode based on the evaluated condition. The payload integrated circuit is configured to generate outbound baseband data signals and receive demodulated data signals. The optical transceiver is coupled to the decision logic module and the payload IC and is configured to transmit and receive optical signals over a free-space optical wireless link using a first modulation format or a second modulation format. The optical array is optically coupled to the optical transceiver for optical signal emission and reception. The mmWave transceiver is coupled to the decision logic module and the payload IC and is configured to transmit and receive mmWave signals over a free-space mmWave link using a third modulation format or a fourth modulation format. The antenna array is coupled to the mmWave transceiver and is configured to emit and receive mmWave signals. The decision logic module is further configured to determine the channel condition based on a signal quality indicator and select one of four transmission modes, comprising optical transmission using the first modulation format, optical transmission using the second modulation format, mmWave transmission using the third modulation format, and mmWave transmission using the fourth modulation format. The first modulation format requires a higher signal-to-noise ratio and provides a higher spectral efficiency than the second modulation format, and the third modulation format requires a higher signal-to-noise ratio and provides a higher data rate than the fourth modulation format.

In accordance with a second aspect of the present invention, a method for satellite communication using hybrid optical and mmWave transceivers is provided. The method includes steps as follows: evaluating, by a decision logic module, a channel condition based on a signal quality indicator; selecting, based on the evaluated channel condition, one of four transmission modes, comprising: (a) optical transmission using a first modulation format, (b) optical transmission using a second modulation format, (c) mmWave transmission using a third modulation format, or (d) mmWave transmission using a fourth modulation format; generating, by a payload integrated circuit, outbound baseband data signals and receiving demodulated data signals; transmitting and receiving, via an optical transceiver optically coupled to an optical array, optical signals over a free-space optical wireless link using either the first modulation format or the second modulation format; transmitting and receiving, via a mmWave transceiver coupled to an antenna array, mmWave signals over a free-space mmWave link using either the third modulation format or the fourth modulation format. The first modulation format requires a higher signal-to-noise ratio and provides a higher spectral efficiency than the second modulation format, and the third modulation format requires a higher signal-to-noise ratio and provides a higher data rate than the fourth modulation format.

By the above configuration, several advantages are achieved, including:

1) a transceiver architecture that enables adaptive switching between optical wireless and mmWave communication under various atmospheric conditions;

2) a method for selecting the appropriate communication mode and modulation format based on four distinct channel scenarios;

3) a coherent optical wireless transceiver design that supports adaptive switching between modulation formats, specifically 16-QAM and PAM-4; and

4) a sliding-IF phased-array transmitter architecture that enables efficient multi-beam synthesis at intermediate frequency using a transadmittance-transimpedance variable gain amplifier.

### Brief Description of Drawings

Embodiments of the invention are described in more details hereinafter with reference to the drawings, in which:

FIG. 1 illustrates an exemplary scenario of a hybrid optical and millimeter-wave (mmWave) network architecture for data transmission in satellite communication;

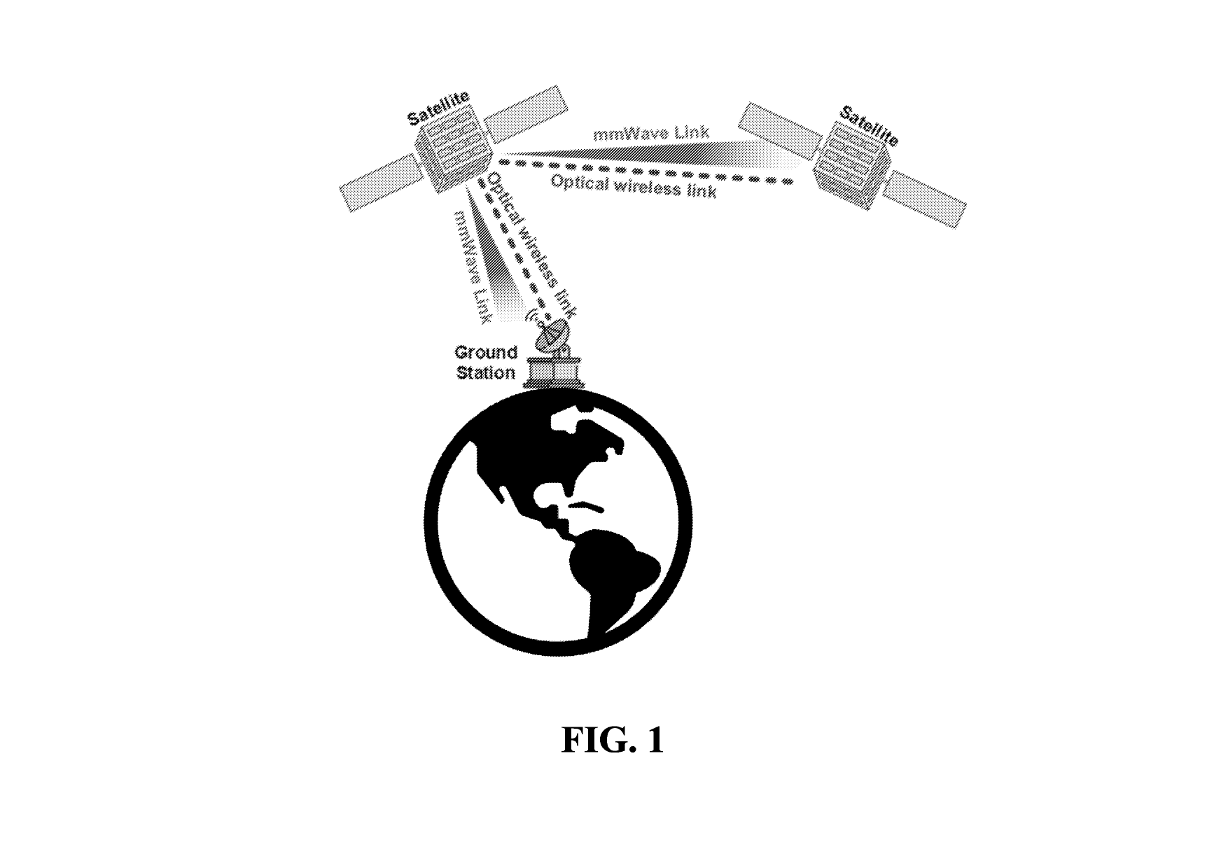

FIG. 2 illustrates a diagram of a system for satellite communication using hybrid optical and mmWave transceivers according to some embodiments of the present invention;

FIG. 3A and FIG. 3B show the operation principle of the hybrid optical/mmWave transceiver, illustrating how the system dynamically selects the communication link and modulation format based on varying channel conditions according to some embodiments of the present invention;

FIG. 4 shows a system diagram of an optical wireless transceiver configured for free-space communication according to some embodiments of the present invention;

FIG. 5A illustrates a conventional mmWave phased-array transmitter architecture;

FIG. 5B illustrates an improved mmWave transmitter architecture based on a sliding IF design according to some embodiments of the present invention; and

FIG. 6 illustrates a diagram of a system for satellite communication using hybrid optical and mmWave transceivers according to some embodiments of the present invention.

### DETAILED DESCRIPTION OF THE INVENTION

In the following description, systems and methods for satellite communication using hybrid optical and millimeter-wave (mmWave) transceivers and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the present innovation, a novel satellite communication approach that leverages a hybrid mmWave/optical wireless communication link is presented, thereby facilitating high-speed, high-capacity, and robust satellite communications. One of the key inventive features is the hybrid mmWave/Optical transceiver integrated circuit (IC), consisting of a phased-array mmWave transceiver supporting simultaneous multibeam function, an optical wireless transceiver supporting adaptive switching between quadrature and pulse amplitude modulation, and a decision logic to switch between the mmWave and optical transceiver under different communication channel conditions.

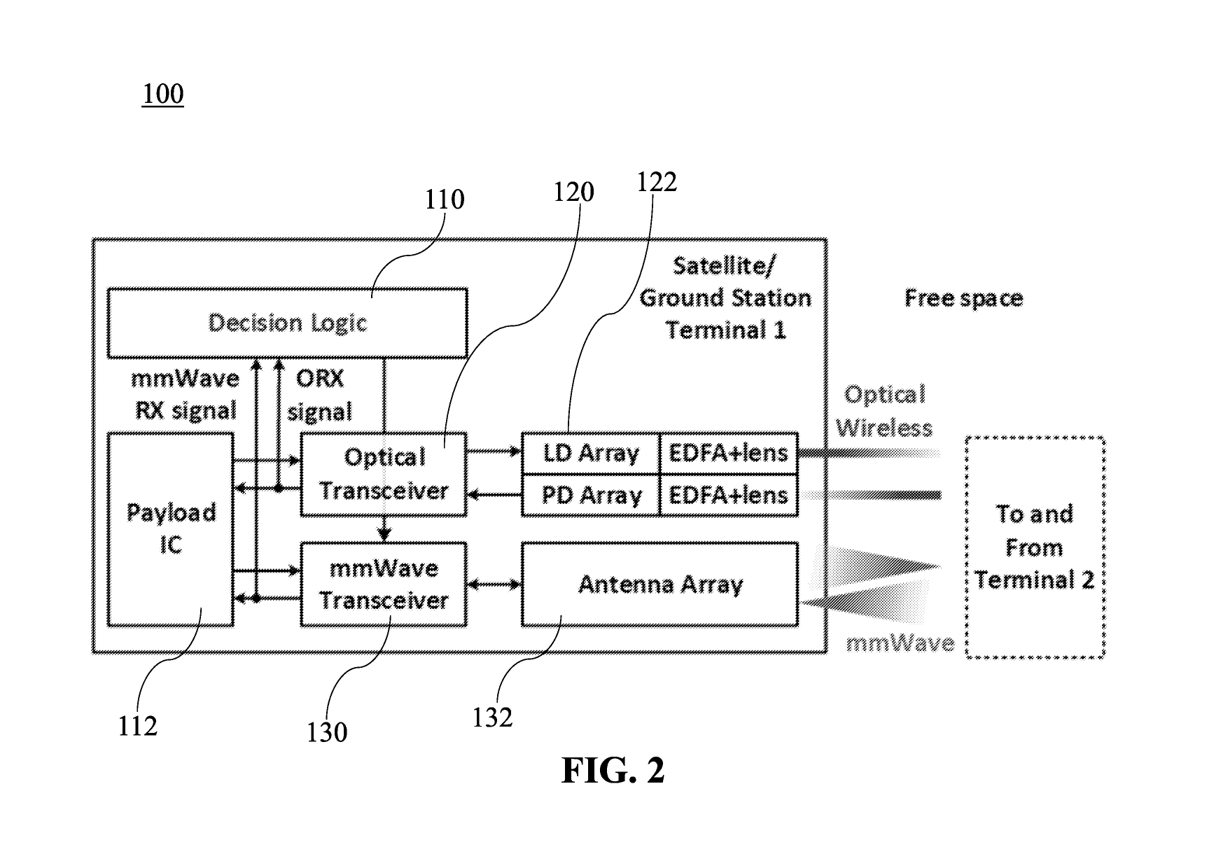

Specifically, FIG. 2 illustrates a diagram of a system 100 for satellite communication using hybrid optical and millimeter-wave (mmWave) transceivers according to some embodiments of the present invention. The system 100 is implemented within a satellite or ground station terminal (i.e., Terminal 1) and is configured to communicate with a remote terminal (i.e., Terminal 2) through free-space propagation using either an optical wireless link or a mmWave link. The selection between the two transmission modes is dynamically determined based on prevailing atmospheric or environmental channel conditions. The optical wireless link operates by directing a highly collimated laser beam through free space, enabling high-capacity line-of-sight communication when unobstructed. In contrast, the mmWave link transmits radio-frequency signals through the atmosphere, offering more robust performance under adverse weather or partially blocked line-of-sight conditions.

The system 100 includes a decision logic module 110, a payload IC 112, an optical transceiver 120, an optical array 122, a mmWave transceiver 130, an antenna array 132. These components are integrated to form a dynamically adaptable transceiver system for hybrid space-ground or intersatellite communication.

The decision logic module 110 is configured to monitor the channel state of both optical and mmWave links. Upon the system 100 startup or wake-up from sleep mode, the decision logic module 110 estimates the availability of the optical wireless channel, and accordingly enables either the optical transceiver 120 or the mmWave transceiver 130. The decision logic module 110 further evaluates the received signal quality to determine a suitable modulation format, selecting between formats such as 16-QAM, PAM-4, or QPSK, depending on the link quality. In favorable conditions, the optical link is prioritized due to its higher bandwidth, while the mmWave link serves as a fallback in adverse weather or signal-blocking environments. In some embodiments, the decision logic module 110 determines the channel condition based on a signal quality indicator and then selects one of four different transmission modes (e.g., four modulation formats). In this regard, the signal quality indicator comprises at least one of signal-to-noise ratio (SNR), bit error rate (BER), received signal strength, or channel response waveform.

The payload IC 112 generates outbound digital data streams, such as telemetry, control instructions, or mission payload data, to be transmitted to the external or remote terminal (e.g., Terminal 2), and receives demodulated data from the optical or mmWave transceiver modules within Terminal 1. These data streams are routed through either the optical or mmWave communication paths depending on the selected link, as determined by the decision logic module 110. The payload IC 112 interfaces with both the mmWave and optical communication paths by supplying baseband signals and receiving decoded outputs. The payload IC 112 also exchanges intermediate signals with the decision logic module 110, such as mmWave RX signal and ORX signal (optical receiver signal), which are used to assist in channel quality evaluation and modulation selection.

The optical transceiver 120 is configured to convert the electrical signal from the payload IC 112 into an optical signal through laser modulation and to perform the reverse process at the receiving end. The optical transceiver 120 interfaces directly with the optical array 122 for physical-layer signal transmission and reception. The optical transceiver supports coherent modulation schemes, including 16-QAM and PAM-4, and its modulation format is adjusted under control of the decision logic module 110 based on signal-to-noise ratio (SNR) and channel availability.

The optical array 122 comprises a laser diode (LD) array for optical signal transmission and a photodiode (PD) array for optical reception. On the transmission side, the modulated optical signal from the optical transceiver 120 is amplified by an Erbium-Doped Fiber Amplifier (EDFA) and collimated using a lens to form a narrow and directional optical beam for free-space transmission. On the receiving side, the incoming optical signal is first collimated by a lens and amplified by another EDFA, before being converted into an electrical signal by the PD array. The use of EDFA and lens on both ends allows for long-range, low-loss optical transmission.

The mmWave transceiver 130 is configured to transmit and receive mmWave signals through a phased array architecture, and interfaces with the antenna array 132. The mmWave transceiver 130 receives input data from the payload IC 112 and delivers beamformed signals to the antenna array 132 for free-space propagation. The phased-array architecture is capable of generating multiple simultaneous beams, allowing space-division multiplexing for multi-user communication. Power and modulation efficiency are further optimized through an intermediate-frequency (IF) signal processing scheme.

The antenna array 132 radiates the beamformed mmWave signals into free space and receives mmWave signals from the remote terminal (e.g., Terminal 2). In intersatellite links, where atmospheric conditions are stable, the system 100 predominantly employs the optical wireless path. For satellite-to-ground communication, the system dynamically switches between the optical and mmWave paths based on real-time weather conditions and signal quality, maintaining robust and high-throughput connectivity.

Specifically, in intersatellite communication scenarios, where free-space channel conditions in outer space are generally favorable and unobstructed, the optical wireless link is preferentially utilized to achieve high data rates and large transmission capacity. For satellite-to-ground communication, where atmospheric variability becomes a critical factor, the system adopts a hybrid strategy. It uses the optical link during clear weather to maximize throughput, and switches to the mmWave path under adverse conditions such as cloud cover or precipitation in order to maintain link continuity, albeit with a slightly reduced data rate.

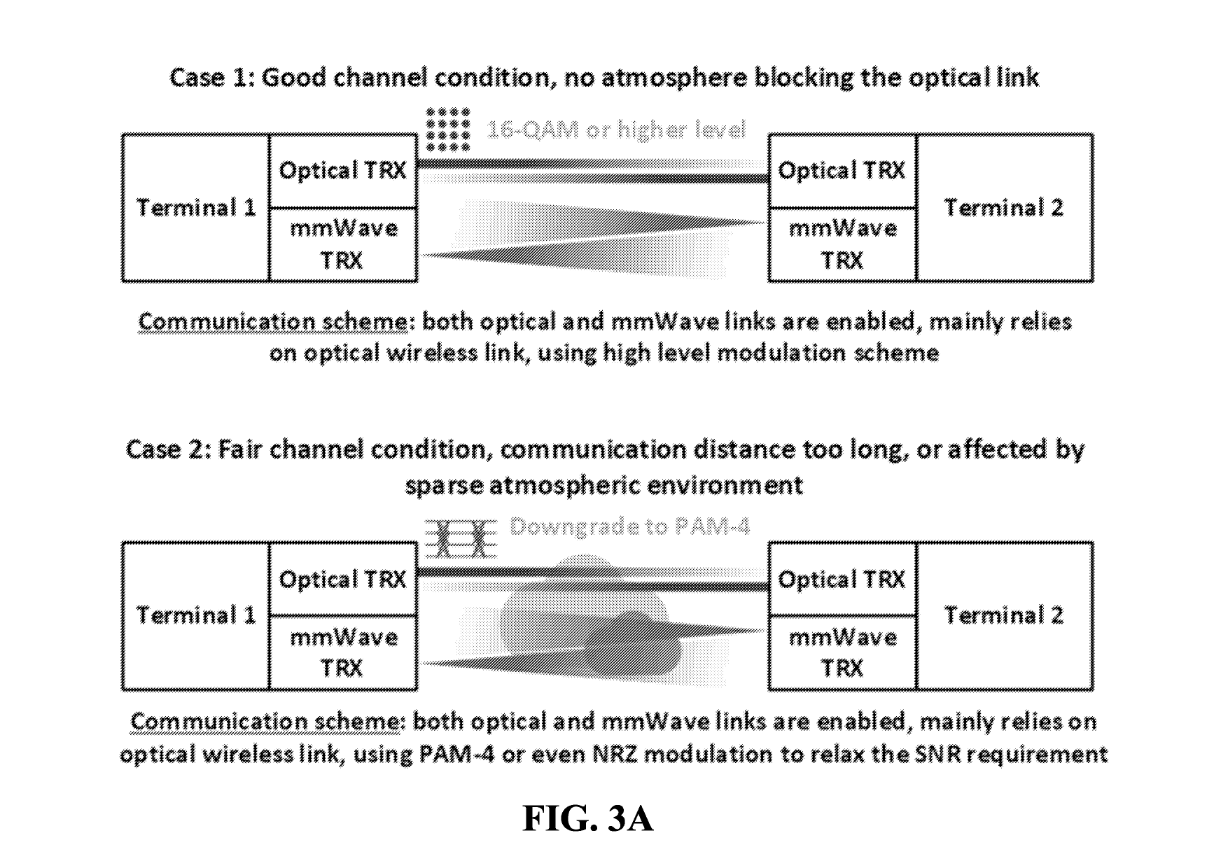

FIG. 3A and FIG. 3B show the operation principle of the hybrid optical/mmWave transceiver, illustrating how the system dynamically selects the communication link and modulation format based on varying channel conditions according to some embodiments of the present invention. To clearly demonstrate the behavior under different free-space and atmospheric environments, FIG. 3A and FIG. 3B collectively categorize potential scenarios into four representative cases, ranging from ideal to severely degraded conditions. Each case highlights the corresponding link selection and modulation strategy employed by the decision logic to maintain optimal communication performance.

In the illustrations, “Terminal 1” refers to the system 100 shown in FIG. 2 and may be implemented in a satellite or ground station. The Terminal 1 includes both an optical transceiver (Optical TRX) and a millimeter-wave transceiver (mmWave TRX), along with supporting logic for link selection and modulation control. In some embodiments, the Optical TRX is configured to convert electrical signals into optical signals for free-space transmission, and vice versa. It includes components such as laser diodes, photodiodes, EDFA amplifiers, and lenses. The Optical TRX supports modulation schemes like 16-QAM and PAM-4, selected based on channel conditions. In some embodiments, the mmWave TRX employs a phased-array architecture for beamforming and supports modulations such as 16-QAM and QPSK. The mmWave TRX provides a more reliable fallback when the optical link is degraded by atmospheric interference. “Terminal 2” is the remote endpoint, which may be another satellite, a ground station, or an external communication unit. The Terminal 2 can adopt the same transceiver architecture as Terminal 1 or use compatible systems such as optical ground receivers or mmWave tracking arrays.

In general, there are a total of four possible channel conditions, and the decision logic module 110 will make optimal communication choices based on these conditions.

As shown in FIG. 3A, In Case 1, when the channel condition is good, meaning that both the optical wireless and mmWave links are unobstructed by atmospheric interference such as clear-space intersatellite communication or satellite-to-ground communication under favorable weather, the system 100 operates in a high-throughput mode. In this condition, the decision logic module 110 evaluates the channel state and instructs the transceiver system to primarily utilize the optical transceiver 120 along with the optical array 122 for data transmission. This optical path supports significantly higher data rates due to its wide bandwidth and strong directionality in free space. Although the mmWave transceiver 130 and antenna array 132 remain enabled, the system 100 gives communication priority to the optical link. With the signal-to-noise ratio at a favorable level, the decision logic module 110 selects a high-level modulation format such as 16-QAM or above to maximize spectral efficiency and throughput.

As shown in FIG. 3A, in Case 2, the optical wireless link remains available, but the received optical power is reduced due to either an extended communication distance or sparse atmospheric scattering, resulting in a lower signal-to-noise ratio (SNR) at the receiver. Under these conditions, the decision logic module 110 determines that the SNR level of the existing signal cannot support the normal transmission of high-order modulation format signals, such as 16-QAM. As a result, the system 100 continues to rely on the optical transceiver 120 and optical array 122 as the primary communication path, but the decision logic module 110 instructs the transceiver to downgrade the modulation format to a lower level, such as PAM-4 (the hardware implementation regarding the modulation format switching will be discussed later). By means of such a downgrade switching scheme in response to the modulation requirement, the system 100 is allowed to sustain long-distance optical communication at a moderately high data rate. During this operation, the mmWave transceiver 130 and antenna array 132 remain active and available for use, providing redundancy or additional data paths as needed.

As shown in FIG. 3B, in Case 3, the optical wireless link becomes completely unavailable due to atmospheric obstruction such as heavy cloud cover or severe weather, resulting in a blocked line-of-sight path. In response, the decision logic module 110 commands the system 100 to disable the optical transceiver 120 and its associated optical array 122, and to switch communication exclusively to the mmWave transceiver 130 and antenna array 132 as a secondary scheme. The mmWave link offers higher robustness under such adverse conditions and remains capable of supporting high-level modulation formats such as 16-QAM or above. Although the achievable data rate may be lower than that of the optical link due to the narrower bandwidth of the mmWave spectrum, this switching mode for the primary and secondary schemes ensures continuous and stable communication between Terminal 1 and Terminal 2.

As shown in FIG. 3B, in Case 4, the channel condition becomes extremely poor, where both the optical wireless link and the mmWave link are severely degraded due to dense atmospheric interference. Under such conditions, the decision logic module 110 determines that the optical transceiver 120 and optical array 122 cannot be used, and communication must rely solely on the mmWave transceiver 130 and antenna array 132. However, the received mmWave signal strength is significantly weakened, resulting in a low signal-to-noise ratio (SNR) that cannot support high-order modulation formats such as 16-QAM. To maintain connectivity, the decision logic module 110 selects a lower-level modulation scheme, such as QPSK, which has a higher noise tolerance. Additionally, the system 100 may reduce the bandwidth of the mmWave link to suppress noise, further improving the SNR effectively, although this adjustment leads to a reduced data rate. This configuration allows the system 100 to sustain basic communication under the most adverse free-space conditions.

The following descriptions provide the operating principles of the optical wireless transceiver and the mmWave transceiver, respectively. These transceivers correspond to the communication modules within the system 100 and are responsible for modulating, transmitting, receiving, and demodulating data over free-space optical and millimeter-wave channels.

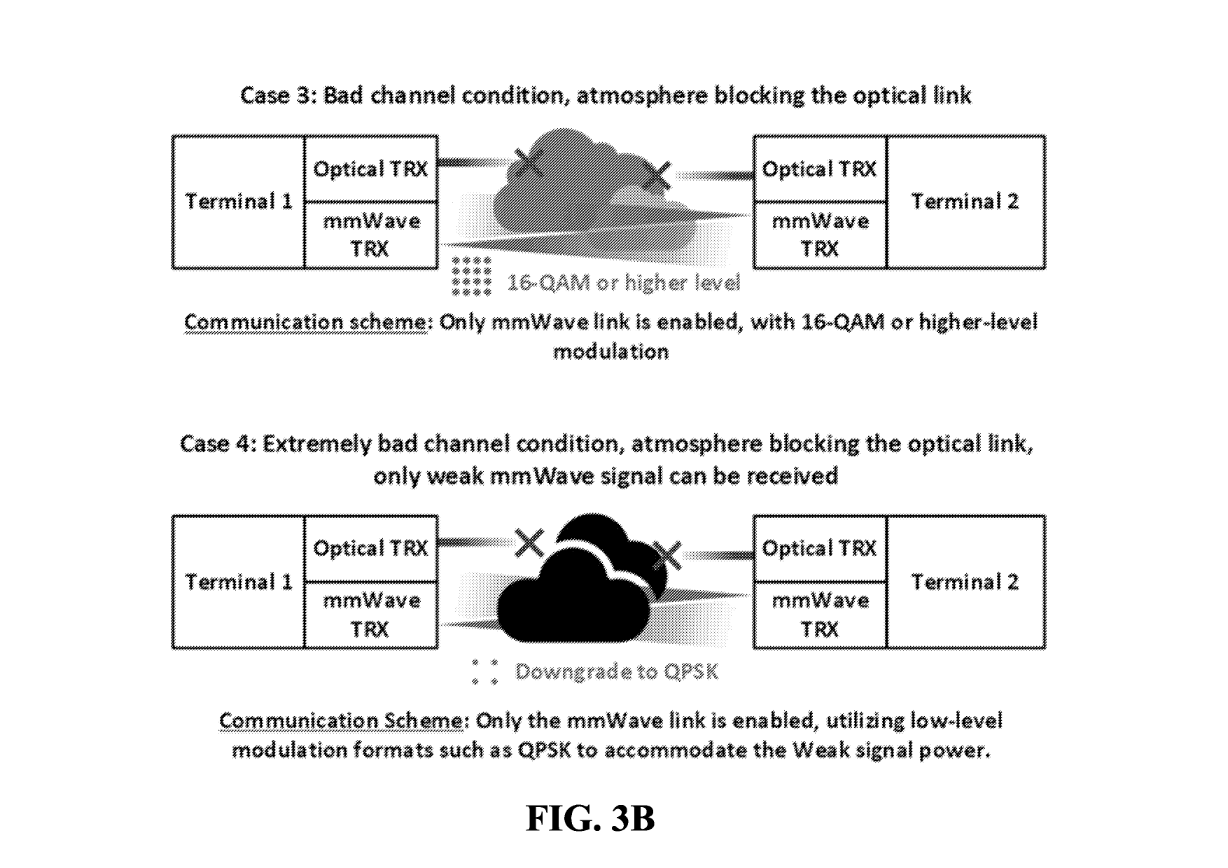

FIG. 4 shows a system diagram of an optical wireless transceiver configured for free-space communication according to some embodiments of the present invention. The optical transceiver 200 (i.e., optical wireless transceiver) includes a coherent optical wireless transmitter 210 and an optical wireless receiver 220. On the transmitter side, coherent 16-QAM modulation is achieved using electrical drivers to control four Mach-Zehnder modulators (MZMs) along with two MZM-based optical phase shifters.

Taking the MZM1 and MZM2 branches as an example, when there is no signal input, the output optical signals from MZM1 and MZM2 are in phase with each other. With an additional optical phase shift of π following MZM1, the optical signals from the two branches become out of phase, resulting in destructive interference and an output signal of zero.

When the differential electrical drivers, I-DRVP and I-DRVN, provide differential driving signals to MZM1 and MZM2, respectively, the optical phase shift from the two branches deviates from 180°. A stronger driving signal will cause the phases of the two optical signals to move closer to being in phase, increasing the overall output optical signal power after superposition. In this way, the electrical signal can be modulated onto the amplitude of the optical signal.

The superposed optical signals from MZM1, MZM2, MZM3, and MZM4 will then undergo phase shifts of θ1 and θ2, respectively. If θ1 - θ2 equals π/2 (i.e., θ1 - θ2 = π/2), the final output signal after combining the signals from the four branches will be an N-QAM modulated signal, such as 16-QAM. Conversely, if θ1 equals θ2 (i.e., θ1 = θ2), the final output signal will be a PAM-N signal, such as PAM-4.

Based on this principle, the decision logic module described in FIG. 2 can support switching between different modulation schemes by controlling the phase shifts θ1 and θ2. The variable phase shift control can be achieved via thermal management. Obviously, the 16-QAM modulation scheme provides higher data rate, while the PAM-4 modulation provides relatively lower data rate, but higher tolerance for SNR.

On the receiver side, the optical signal is collimated by a lens, amplified by an EDFA, and then combined with a local optical signal using an optical hybrid. The output from the optical hybrid is received by two pairs of balanced photodiodes (PDs) to recover the I and Q electrical signals, respectively. The analog electrical signals pass through a variable gain amplifier (VGA), are then digitized by a high-speed ADC, and finally deserialized and equalized in a digital signal processing unit.

In this regard, the optical wireless transmitter 210 is at least configured to: convert in-phase and quadrature baseband data signals into differential analog signals via digital-to-analog converters and driver amplifiers; modulate a laser output using a plurality of Mach-Zehnder modulators arranged to generate QAM or PAM optical signals; and amplify and collimate the modulated optical signal using an erbium-doped fiber amplifier and a lens for free-space transmission. The optical wireless receiver 220 is at least configured to: receive and amplify a collimated free-space optical signal; coherently mix the received signal with a local oscillator using an optical hybrid; detect in-phase and quadrature components using two pairs of balanced photodiodes; amplify the electrical outputs using transimpedance and variable gain amplifiers, and digitize and process the signals using analog-to-digital converters and a digital signal processor.

More specifically, as the configuration shown in FIG. 4, there are a coherent transmission and reception chain starting from a pair of digital baseband data signals, labeled Data 1 and Data 2. These two data streams are first converted into analog signals via two separate digital-to-analog converters (DACs), each corresponding to the in-phase (I) and quadrature (Q) components of the signal. The I-channel DAC output is fed into two differential drivers (I-DRVP and I-DRVN), while the Q-channel DAC output is fed into two corresponding drivers (Q-DRVP and Q-DRVN). These differential driver pairs provide high-speed analog signals to control a set of four Mach-Zehnder modulators (MZM1-MZM4), arranged in a nested structure to perform dual-polarization modulation.

MZM1 and MZM2 form the I-path modulation branch, and MZM3 and MZM4 form the Q-path branch. Each MZM modulates the optical carrier signal, which is derived from a laser source, according to the analog electrical signal received from the drivers. The modulated outputs from the MZMs are phase-shifted by amounts θ1 and θ2, which are thermally tuned through an integrated thermal control circuit. The values of θ1 and θ2 determine the modulation format: setting θ1-θ2 to approximately π/2 yields a quadrature amplitude modulation (QAM) format, such as 16-QAM, while setting θ1=θ2 results in a pulse amplitude modulation (PAM) format, such as PAM-4.

The composite optical signal, after amplitude and phase modulation, is amplified by an EDFA to enhance transmission power, and then collimated by a lens for free-space propagation toward a remote terminal.

Next, at the receiver side, the incoming optical signal is first collimated and amplified through a second lens-EDFA combination, then coherently mixed with a local oscillator laser signal using an optical hybrid. The hybrid generates four output optical paths corresponding to the I and Q signal branches. These signals are directed to two pairs of balanced PDs, which convert the optical fields into differential electrical currents. Each pair is dedicated to either the I or Q component. The electrical outputs from the PDs are passed through transimpedance amplifiers (TIAs) and variable gain amplifiers (VGAs) to provide stable analog signals with adjustable amplitude.

The resulting I and Q analog signals are digitized by high-speed analog-to-digital converters (ADCs), producing digital samples that are further processed by a digital signal processor (DSP). The DSP performs signal equalization, clock and carrier recovery, demodulation, and data reassembly, ultimately producing recovered digital data that corresponds to the original Data 1 and Data 2 signals.

Accordingly, based on this operating mechanism, when implemented as part of the system 100 shown in FIG. 2, the optical wireless transceiver is realized through the optical transceiver 120 and the optical array 122. The optical transceiver 120 incorporates the coherent modulation architecture described in FIG. 4, including the Mach-Zehnder modulators and optical phase shifters, and is configured to generate either 16-QAM or PAM-4 optical signals depending on channel conditions. This modulation format is selected under the control of the decision logic module 110, which dynamically adjusts the relative phase shifts θ1 and θ2 according to the estimated signal-to-noise ratio. The control of these phase shifts may be achieved through thermal tuning or similar mechanisms integrated into the modulator array.

The optical array 122, as integrated within system 100, provides the physical interface for the optical signal path described in FIG. 4. On the transmitter side, the array includes the laser diode sources that supply continuous-wave optical carriers to the coherent optical transmitter described in FIG. 4. These carriers are modulated through four Mach-Zehnder modulators (MZM1-MZM4) under the control of differential electrical drivers, forming the I and Q signal branches. The modulated optical outputs are then passed through integrated EDFAs to boost power levels before being collimated by lenses for free-space propagation.

On the receiver side, the incoming optical signal is first collimated and amplified, and then mixed with a local oscillator optical signal through an optical hybrid, as shown in FIG. 4. The hybrid outputs are connected to balanced photodiodes, which generate differential electrical signals corresponding to the I and Q components. These signals are then routed through a variable gain amplifier and digitized via high-speed ADCs, enabling signal recovery and demodulation within the digital signal processing chain. All signal routing between the optical array 122 and the modulation/demodulation elements within the optical transceiver 120 follows to the coherent optical architecture illustrated in FIG. 4.

The payload IC 112 provides baseband digital data to the optical transceiver 120 for modulation, and also receives the recovered I and Q signals after photodetection and analog-to-digital conversion on the receiver side. In parallel, the decision logic module 110 continuously monitors link conditions, including received signal power and error performance, and selects the optimal modulation format to maintain data throughput and communication reliability.

As such, the optical communication path in system 100 supports adaptive, high-speed, and directionally focused free-space transmission. The configuration allows the system 100 to respond to changing atmospheric or distance-induced impairments by reconfiguring its modulation format without requiring hardware replacement or physical intervention.

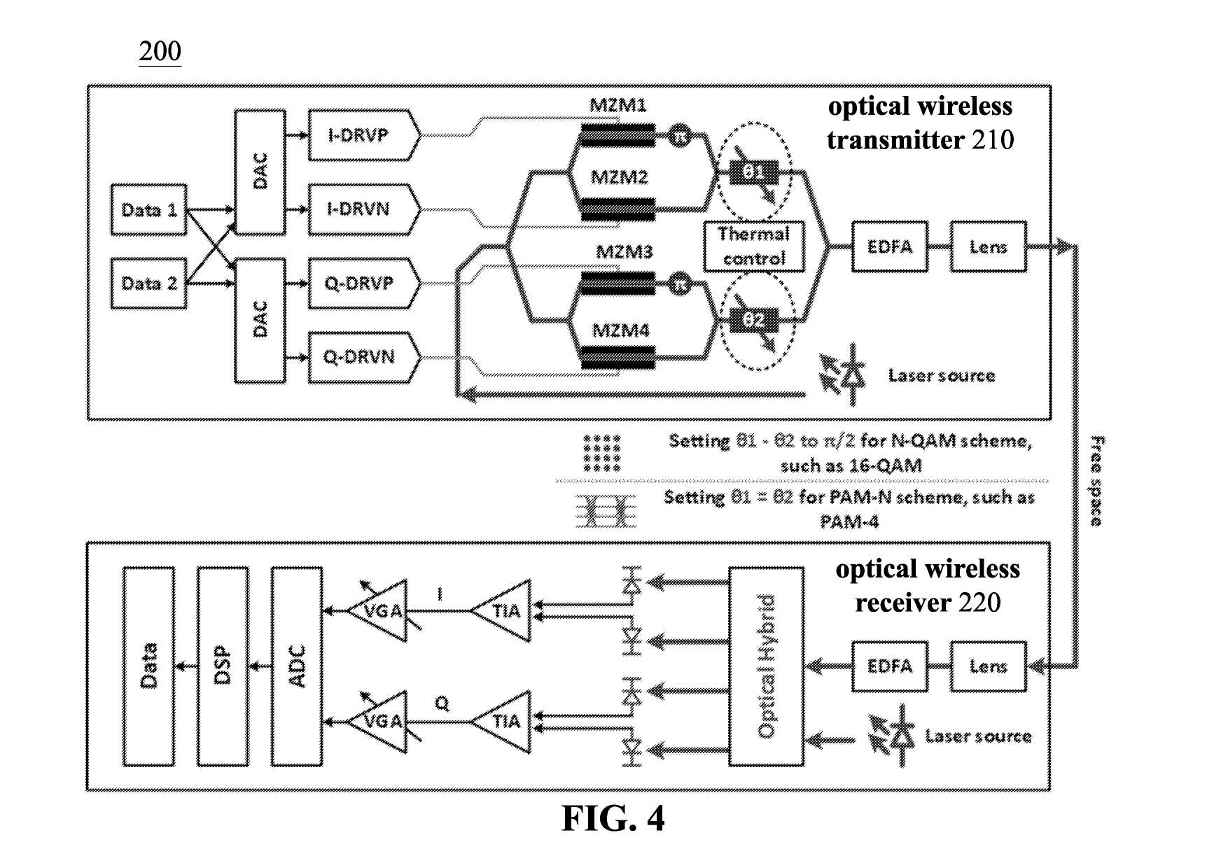

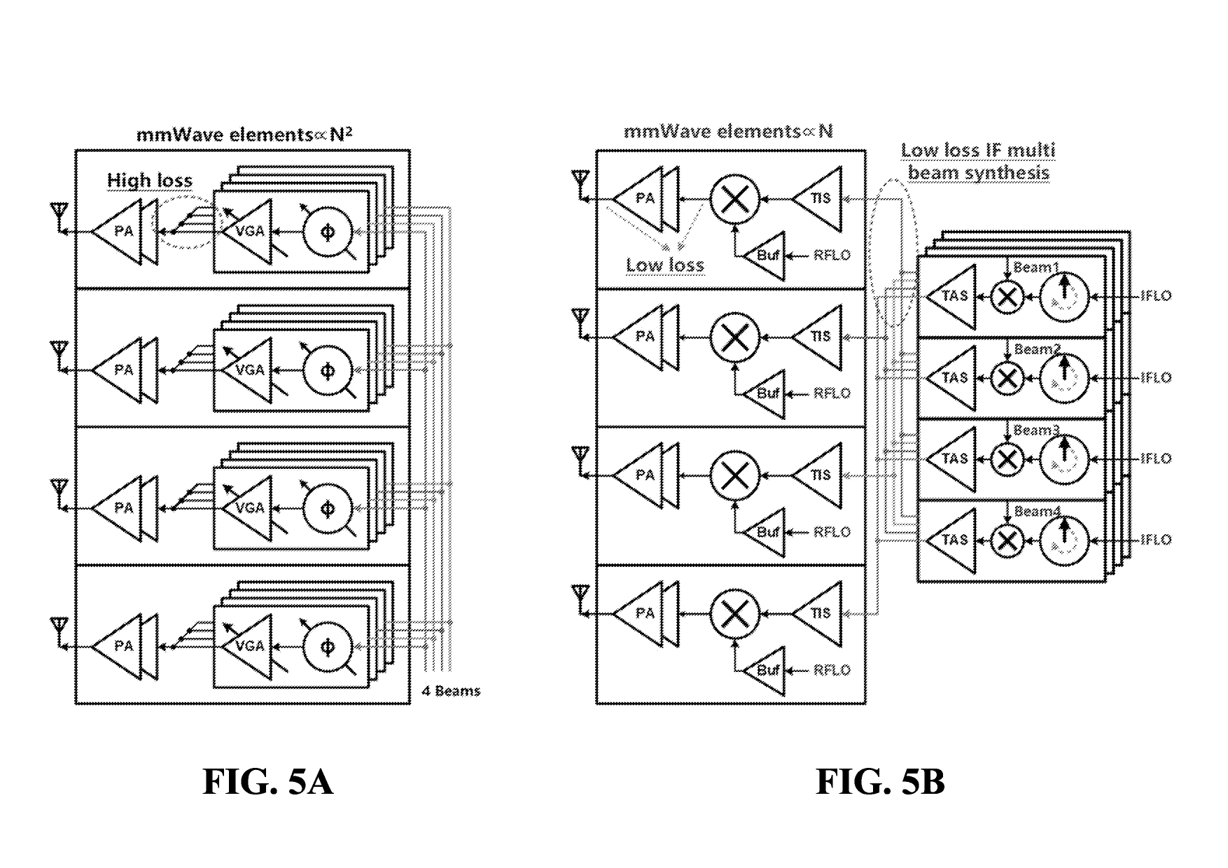

FIG. 5A illustrates a conventional mmWave phased-array transmitter architecture, in which the number of mmWave elements increases proportionally to the square of the number of beams, resulting in high signal distribution loss. FIG. 5B illustrates an improved mmWave transmitter architecture based on a sliding IF design according to some embodiments of the present invention, which reduces signal loss and enables efficient multi-beam synthesis with fewer mmWave elements.

For the mmWave transceiver, a key requirement is to support simultaneous multi-beam functionality to enable data transmission to multiple users at the same time. A conventional mmWave phased-array transmitter circuit is illustrated in FIG. 5A, which can simultaneously provide four beams using four antennas. To achieve this, the data from the four beams must be processed by a total of 16 phase shifters and variable gain amplifiers (VGAs) operating at mmWave frequencies. These 16 phase shifters and VGAs effectively function as a 4-by-4 matrix, processing the four input data streams and synthesizing four output mmWave signals to be fed into the power amplifier (PA) for transmission through the antennas.

The major drawback of this architecture is that the number of mmWave elements increases proportionally to the square of the number of beams (N²). Additionally, there is significant power loss in the power combining and power splitting paths within the signal distribution due to the mmWave frequency intrinsic character.

In the present invention, a sliding-IF architecture is adopted, which supports efficient multi-beam synthesis at an intermediate frequency (IF) that is 1/M of the RF frequency, where M is typically 5. As shown in FIG. 5B, the four data streams for the four beams are upconverted to the mmWave frequency through a two-step frequency upconversion process. In the first step, the input data is mixed with the IF local oscillator (IFLO) to produce the IF signal. The phase shift and gain control functions are applied to the IFLO and IF signals, respectively. The IFLO signal is typically generated by dividing the RF local oscillator (RFLO) signal by 4. Thus, implementing phase shift and gain control in the IF path can be very power- and area-efficient.

Furthermore, a transadmittance-transimpedance (TAS-TIS) architecture is utilized for the IF variable gain control, where the input signal is first converted into a current domain signal, providing variable gain amplification during this process. The gain-controlled current domain signal is then converted back to the voltage domain using a second-stage transimpedance amplifier. Importantly, the multi-beam synthesis function can be performed in the current domain at the output of the TAS. Since the current domain signal is not subject to voltage supply limitations, multi-beam synthesis with high linearity can be achieved. Additionally, because the IF frequency is much lower than the mmWave frequency, the power efficiency of the multi-beam synthesis is significantly enhanced.

The synthesized multi-beam signals are then fed into the N mmWave elements, which undergo a second frequency upconversion before being sent to the PA and antenna. Unlike conventional architectures, where the number of mmWave elements is proportional to N², in this architecture, the number of elements is only proportional to N. Therefore, the overall power and area efficiency can be greatly improved.

The configuration described above may be implemented as a mmWave transceiver 230 in FIG. 5B. The mmWave transceiver 230 incorporates the sliding intermediate frequency (IF) architecture discussed in the preceding paragraphs, and is configured to perform beamforming and gain control at the IF stage. Each data stream is first mixed with an IF local oscillator (IFLO) signal via a first-stage mixer to generate an intermediate-frequency signal, and then upconverted to a mmWave frequency using a second-stage mixer driven by a RF local oscillator (RFLO).

Furthermore, the transceiver comprises a transadmittance amplifier configured to convert the IF signal into a current-domain signal, followed by a transimpedance amplifier that converts the current-domain signal back to the voltage domain. The current-domain outputs enable multi-beam synthesis to be performed at the output of the transadmittance amplifier, offering improved linearity and power efficiency due to operation at a lower frequency.

Based on this operating mechanism, when implemented as part of the system 100 shown in FIG. 2, the sliding-IF mmWave transmitter architecture is realized through the mmWave transceiver 130 and the antenna array 132. The mmWave transceiver 130 includes the IF-domain signal processing chain described in FIG. 5B, where beamforming and gain control are performed at intermediate frequency using the transadmittance (TAS) and transimpedance (TIS) stages. The four input data streams are supplied by the payload IC 112 and are first converted into IF signals using IF local oscillators derived from the RFLO. The beam-specific gain and phase adjustments are applied in the current domain, enabling low-loss, high-linearity multi-beam synthesis.

The synthesized IF signals for each beam are then passed through a second frequency upconversion stage and transmitted to the antenna array 132 via power amplifiers. Because beam synthesis is performed at IF and the number of mmWave chains scales only with the number of beams (N, where N is a positive integer), the system 100 achieves improved power efficiency and reduced circuit complexity. The decision logic module 110 may further configure the modulation format for each mmWave beam based on link quality, maintaining robust multi-user communication across dynamically changing channel environments.

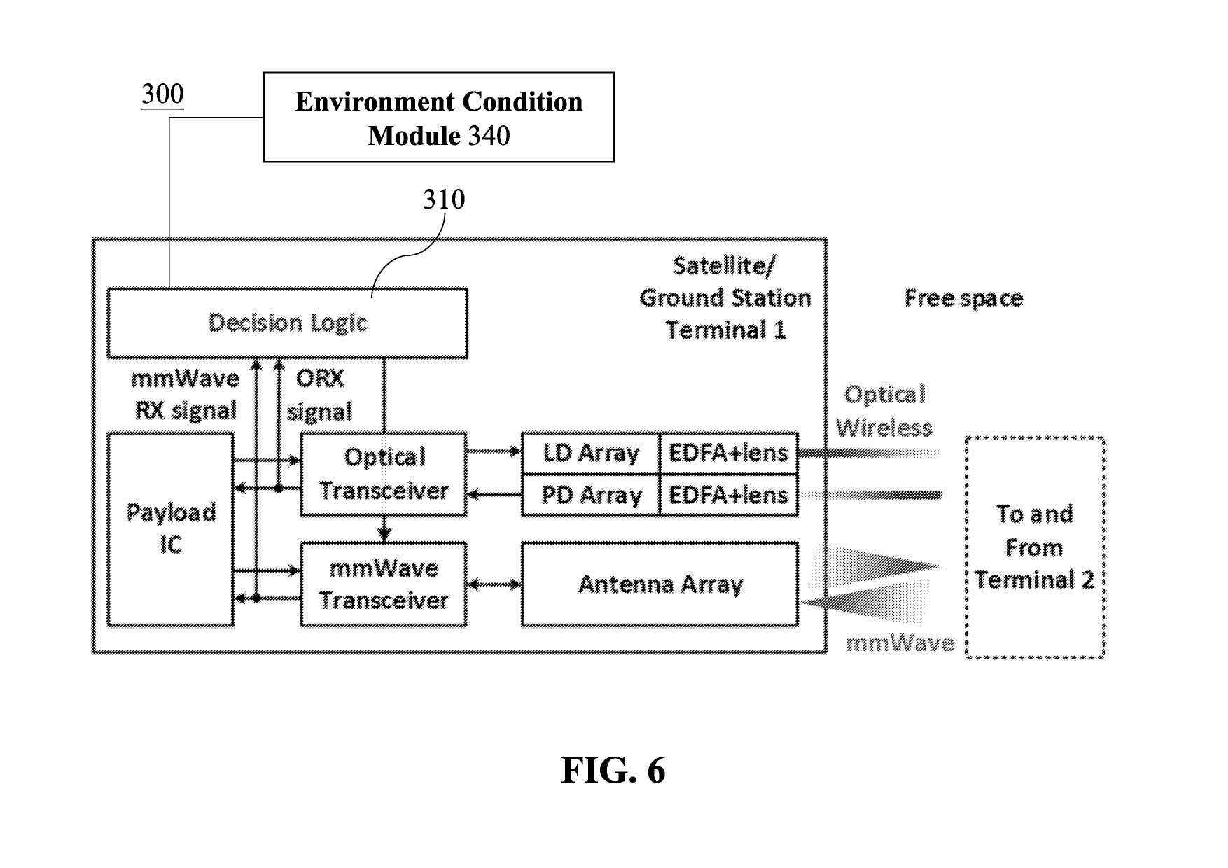

FIG. 6 illustrates a diagram of a system 300 for satellite communication using hybrid optical and mmWave transceivers according to some embodiments of the present invention. The system 300 has a configuration similar to that of the previously described system 100, except that it further includes an environment condition module 340.

The environment condition module 340 is configured to evaluate atmospheric or channel conditions at the initiation of communication between Terminal 1 and Terminal 2, particularly in situations where the operating conditions are uncertain or fluctuating. Prior to selecting the transmission mode, Terminal 1 may transmit a probing signal according to the four communication cases described previously (Case 1 through Case 4), and await a response signal from Terminal 2. The environment condition module 340 analyzes the received response signal to infer the most suitable transmission scheme. In one example, the analysis may involve direct waveform inspection of the returned signal.

In some embodiments, the environment condition module 340 employs a correlation-based method to identify the appropriate data transmission scheme based on received response signal characteristics. To facilitate this correlation analysis, a standard training pattern is stored in on-chip memory of the system 300 to assist environment evaluation. This training pattern may be sent either before continuous communication starts or inserted as a prefix within each communication packet during continuous communication. Upon receiving the transmitted training pattern, the environment condition module 340 performs a correlation validation between the received pattern and the pre-stored pattern (e.g., by comparing the received signal characteristics to the preloaded reference). Based on the correlation level detected, the channel condition is determined, and an appropriate communication scheme is then selected accordingly.

In some embodiments, the environment condition module 340 includes a machine learning (ML) model or artificial intelligence (AI) model configured to classify return signals from Terminal 2 for the purpose of selecting an appropriate transmission case. The ML model or AI model may be trained using supervised or semi-supervised learning techniques on a dataset consisting of labeled signal patterns corresponding to different environmental conditions and channel scenarios. Each training sample may include time-domain or frequency-domain representations of return signals, annotated with the optimal transmission mode (e.g., optical with 16-QAM, optical with PAM-4, mmWave with 16-QAM, or mmWave with QPSK).

In one example, the training data may consist of short-duration signal captures, such as 10 to 100 microseconds of received waveform sampled at a high resolution (e.g., several hundred mega-samples per second). These time-domain signals can optionally be transformed into the frequency domain using fast Fourier transform (FFT) operations to reveal spectral characteristics, noise bands, and harmonic features relevant to classification. Both raw and transformed representations may be used as input features, depending on model architecture.

In some embodiments, the AI model may comprise a convolutional neural network (CNN), a recurrent neural network (RNN), a transformer model, or other architectures capable of pattern recognition in signal data. During inference, the environment condition module 340 receives the response signal from Terminal 2, extracts a predefined time segment, performs necessary preprocessing such as normalization or domain transformation, and feeds the processed signal into the model.

The ML model or AI model outputs a classification label or confidence vector indicating the estimated channel condition or best-matching case among the predefined transmission scenarios. This output is used to guide the decision logic module 310 in selecting the optimal transceiver path and modulation scheme prior to active data transmission. The proposed AI-assisted approach allows the system 300 to anticipate atmospheric effects, scattering, or link degradation before relying solely on live SNR feedback.

By leveraging signal pattern recognition through AI-assisted interpretation, the environment condition module 340 enhances the robustness and adaptability of the hybrid communication system under ambiguous or time-varying free-space environments. The pre-communication inference mechanism provides an additional decision layer beyond real-time signal-to-noise monitoring, allowing the system 300 to proactively determine the most appropriate link configuration before active data exchange begins.

In both system 100 and system 300, the decision logic module 110 is configured to dynamically switch between the four transmission cases described previously (e.g., optical with 16-QAM, optical with PAM-4, mmWave with 16-QAM, and mmWave with QPSK). As used herein, the term “dynamically” refers to the system’s ability to transition from one transmission mode to another in real-time in response to changing channel or environmental conditions. For example, the system (e.g., the system 100 or 300) may initially operate under Case 1 (optical link with high SNR), but upon detecting increased atmospheric scattering or degradation in received optical power, the decision logic may switch to Case 2 (optical with PAM-4). If conditions worsen further, such as during dense fog or heavy rain, the system may transition to Case 3 or Case 4, depending on mmWave link availability and quality. Conversely, if the channel condition improves (e.g., atmospheric clearing or satellite repositioning), the system may revert from a lower-efficiency mode back to a higher-efficiency one.

To maintain communication continuity during such transitions, the payload IC may include a data alignment buffer or synchronization unit. This component (i.e., data alignment buffer or the synchronization unit) is configured to temporarily store outgoing and incoming data during the mode-switching interval, achieving that the data stream before and after the switch remains logically contiguous from the perspective of higher-layer protocols or the remote terminal. The data alignment buffer or synchronization unit may operate as a first-in-first-out (FIFO) queue, a dual-port memory, or any other structure capable of coordinating the transition between disparate modulation formats and physical-layer paths, such that data is neither lost nor duplicated across the switching boundary. In some embodiments, the data alignment buffer or synchronization unit may be further configured to replicate or replay the most recent segment of transmitted data after the transmission mode is switched. This allows the receiver to compensate for any transient packet loss that may occur during the switching window, especially in cases where the prior communication mode is degraded due to atmospheric fading or link disruption. The retransmitted data window may be determined based on a predefined temporal threshold or a data count metric (e.g., last N packets or M milliseconds of data), and may be tagged with metadata to enable the receiver to recognize and eliminate duplicates if necessary.

As used throughout this disclosure, the term transmission mode refers to a specific combination of communication link type (optical or millimeter-wave) and modulation format (e.g., high-order or low-order). The system described herein dynamically selects among four distinct transmission modes in response to varying atmospheric or channel conditions. The four transmission modes are further characterized/defined as follows:

Optical with 16-QAM: a high-order modulation mode implemented over a coherent optical wireless link. This mode achieves high spectral efficiency, typically around 4 bits per second per Hertz (bps/Hz), and requires a relatively high signal-to-noise ratio (SNR), generally above 15 dB, for reliable demodulation. It is suitable for short- to mid-range line-of-sight free-space conditions with minimal atmospheric disturbance.

Optical with PAM-4: a lower-complexity modulation format using four-level pulse amplitude modulation over an optical link. This mode offers moderate data rates at reduced SNR thresholds, generally around 12-14 dB, and maintains higher receiver sensitivity than 16-QAM. It is advantageous in long-distance or partially degraded optical conditions.

Millimeter-wave with 16-QAM: a high-throughput radio-frequency mode using phased-array beamforming over mmWave channels. This mode also delivers approximately 4 bps/Hz under favorable RF propagation conditions but is more susceptible to atmospheric fading than QPSK. It supports communication ranges of 1-2 km with required SNR above 15 dB.

Millimeter-wave with QPSK: a robust fallback mode using quadrature phase shift keying on mmWave links. This modulation requires lower SNR, generally around 8-10 dB, and maintains stable communication under dense atmospheric interference. Its spectral efficiency is lower (around 2 bps/Hz), but it provides extended range and noise resilience.

In the present disclosure, 16-QAM is referred to as a high-level modulation format, while PAM-4 and QPSK are referred to as lower-level modulation formats. These classifications reflect their respective trade-offs between data rate, noise tolerance, and transmission range. The selection among these modes is governed by the system’s decision logic based on real-time or predictive channel assessments.

As discussed above, in the present invention, a novel transceiver architecture for satellite communications is introduced, facilitating communication both between satellites and between satellites and ground stations. This architecture employs a hybrid optical wireless and mmWave transceiver capable of switching between the two communication methods based on free space channel conditions, while also providing adaptive modulation schemes. By dynamically selecting the appropriate communication method and modulation format, the system can support high-speed and robust communication across various atmospheric environments. To enable these functions, implementation methods for both the optical and mmWave transceivers are detailed, featuring an adaptive modulation scheme for the optical transceiver and a power-efficient simultaneous multi-beam mmWave phased-array transmitter. Compared to conventional approaches, this invention has the potential to deliver higher data rates, enhanced robustness, and improved power and area efficiency.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for satellite communication using hybrid optical and millimeter-wave (mmWave) transceivers, comprising:
a decision logic module configured to evaluate a channel condition and select a transmission mode based on the evaluated channel condition;
a payload integrated circuit configured to generate outbound baseband data signals and receive demodulated data signals;
an optical transceiver coupled to the decision logic module and the payload IC and configured to transmit and receive optical signals over a free-space optical wireless link using a first modulation format or a second modulation format;
an optical array optically coupled to the optical transceiver for optical signal emission and reception;
a mmWave transceiver coupled to the decision logic module and the payload IC and configured to transmit and receive mmWave signals over a free-space mmWave link using a third modulation format or a fourth modulation format; and
an antenna array coupled to the mmWave transceiver and configured to emit and receive mmWave signals;
wherein the decision logic module is further configured to determine the channel condition based on a signal quality indicator and select one of four transmission modes, comprising optical transmission using the first modulation format, optical transmission using the second modulation format, mmWave transmission using the third modulation format, and mmWave transmission using the fourth modulation format, and wherein the first modulation format requires a higher signal-to-noise ratio and provides a higher spectral efficiency than the second modulation format, and the third modulation format requires a higher signal-to-noise ratio and provides a higher data rate than the fourth modulation format.

2. The system of claim 1, wherein the first modulation format is 16-QAM, the second modulation format is PAM-4, the third modulation format is 16-QAM, and the fourth modulation format is QPSK.

3. The system of claim 1, wherein the signal quality indicator comprises at least one of signal-to-noise ratio (SNR), bit error rate (BER), received signal strength, or channel response waveform.

4. The system of claim 1, wherein the optical transceiver comprises multiple Mach-Zehnder modulators and is configured to switch between the first and second modulation formats by adjusting a phase difference between two optical branches, such that a phase difference of approximately π/2 results in quadrature amplitude modulation, and a phase difference of zero results in pulse amplitude modulation.

5. The system of claim 1, wherein the mmWave transceiver comprises a sliding intermediate frequency (IF) architecture configured to perform beamforming and gain control at the IF stage.

6. The system of claim 1, wherein the optical transceiver comprises:
an optical wireless transmitter configured to:
convert in-phase and quadrature baseband data signals into differential analog signals via digital-to-analog converters and driver amplifiers; and
modulate a laser output using a plurality of Mach-Zehnder modulators arranged to generate quadrature amplitude modulation (QAM) or pulse amplitude modulation (PAM) optical signals; and
an optical wireless receiver configured to:
receive and amplify a collimated free-space optical signal;
coherently mix the received optical signal with a local oscillator using an optical hybrid;
detect in-phase and quadrature components;
amplify electrical outputs using transimpedance and variable gain amplifiers; and
digitize and process the amplified electrical outputs using analog-to-digital converters and a digital signal processor.

7. The system of claim 1, wherein the mmWave transceiver is configured to upconvert each data stream through a two-stage frequency conversion process, and wherein the mmWave transceiver further comprises:
a first-stage mixer combining the data stream with an intermediate-frequency local oscillator (IFLO) signal to generate an IF signal, and
a second-stage mixer upconverting the IF signal to produce a mmWave frequency using a radio-frequency local oscillator (RFLO) signal.

8. The system of claim 1, wherein the mmWave transceiver further comprises:
a transadmittance amplifier configured to convert an input signal to a current-domain signal; and
a transimpedance amplifier configured to convert the current-domain signal back to a voltage-domain signal, wherein multi-beam synthesis is performed in the current domain at the output of the transadmittance amplifier.

9. The system of claim 1, wherein the mmWave transceiver comprises N mmWave elements to support N simultaneous beams, such that the number of mmWave elements scales linearly with the number of beams, and wherein N is a positive integer.

10. The system of claim 1, further comprising:
an environment condition module configured to transmit a probing signal to a remote terminal, receive a response signal, and determine the channel condition by analyzing waveform data of the response signal, wherein the environment condition module comprises a machine learning model trained on labeled waveform data to classify transmission conditions and recommend one of the four transmission modes for the decision logic module.

11. A method for satellite communication using hybrid optical and millimeter-wave (mmWave) transceivers, comprising:
evaluating, by a decision logic module, a channel condition based on a signal quality indicator;
selecting, based on the evaluated channel condition, one of four transmission modes, comprising:
(a) optical transmission using a first modulation format,
(b) optical transmission using a second modulation format,
(c) mmWave transmission using a third modulation format, or
(d) mmWave transmission using a fourth modulation format;
generating, by a payload integrated circuit, outbound baseband data signals and receiving demodulated data signals;
transmitting and receiving, via an optical transceiver optically coupled to an optical array, optical signals over a free-space optical wireless link using either the first modulation format or the second modulation format;
transmitting and receiving, via a mmWave transceiver coupled to an antenna array, mmWave signals over a free-space mmWave link using either the third modulation format or the fourth modulation format;
wherein the first modulation format requires a higher signal-to-noise ratio and provides a higher spectral efficiency than the second modulation format, and the third modulation format requires a higher signal-to-noise ratio and provides a higher data rate than the fourth modulation format.

12. The method of claim 11, wherein the first modulation format is 16-QAM, the second modulation format is PAM-4, the third modulation format is 16-QAM, and the fourth modulation format is QPSK.

13. The method of claim 11, wherein the signal quality indicator comprises at least one of signal-to-noise ratio (SNR), bit error rate (BER), received signal strength, or channel response waveform.

14. The method of claim 11, further comprising:
adjusting a phase difference between two optical branches of a Mach-Zehnder modulator structure in the optical transceiver, wherein a phase difference of approximately π/2 results in generation of a quadrature amplitude modulation (QAM) signal, and a phase difference of approximately zero results in generation of a pulse amplitude modulation (PAM) signal.

15. The method of claim 11, further comprising:
performing beamforming and gain control at an intermediate frequency (IF) stage in the mmWave transceiver using a sliding-IF architecture.

16. The method of claim 11, further comprising:
upconverting each data stream in the mmWave transceiver through a two-stage frequency conversion process which comprises:
mixing the data stream with an intermediate-frequency local oscillator (IFLO) signal to generate an intermediate-frequency signal; and
mixing the intermediate-frequency signal with a radio-frequency local oscillator (RFLO) signal to produce a mmWave signal.

17. The method of claim 11, further comprising:
converting an input signal to a current-domain signal using a transadmittance amplifier in the mmWave transceiver;
performing multi-beam synthesis in the current domain at the output of the transadmittance amplifier; and
converting the current-domain signal back to a voltage-domain signal using a transimpedance amplifier.

18. The method of claim 11, further comprising:
detecting a change in the channel condition that causes a transition from a first transmission mode to a second transmission mode, wherein the first transmission mode is selected from one of (a)–(d), and the second transmission mode is one of the remaining transmission modes which is different than the first transmission mode.

19. The method of claim 18, further comprising:
detecting a subsequent change in the channel condition; and
initiating a second transition, wherein the second transition comprises either:
(i) reverting to the first transmission mode if the original condition has recovered; or
(ii) switching to a third transmission mode if the channel condition has further degraded or changed.
